(19) United States
(12) Patent Application Publication
(10) Pub. No.: US 2021/0132432 A1
(43) Pub. Date: May 6, 2021

(54) DISPLAY APPARATUS

(71) Applicant: SAKAI DISPLAY PRODUCTS CORPORATION, Sakai-shi, Osaka (JP)

(72) Inventor: TOMOO SASAKI, Sakai-shi, Osaka (JP)

(21) Appl. No.: 16/488,741

(22) PCT Filed: Mar. 3, 2017
(86) PCT No.: PCT/JP2017/008603

§ 371 Date: Aug. 26, 2019

(51) Int. Cl. G02F 1/1333; G02F 1/13357

(52) U.S. Cl. CPC G02F 1/133314; G02F 1/133608; G02F 1/13332; G02F 1/133605; G02F 1/133603; G02F 1/133606; G02F 1/133317

(57) ABSTRACT

A display apparatus 1 comprises a housing 2; a display panel 6; and a diffusion plate 8 and a light source portion 10 arranged at a region defined by the housing 2 and the display panel 6. The diffusion plate 8 comprises a first surface 8a facing a surface opposite to a display surface of the display panel 6, and a second surface 8b being a surface opposite to the first surface 8a. The housing 2 comprises a first part 3 having an aperture 3a being closed by the display panel 6, and a second part 4 comprising an inner surface 41a facing the second surface 8b, the second part 4 being made of a resin, and the light source portion 10 is arranged at the inner surface 41a. The outermost shell of the display apparatus 1 is formed by the housing 2 and the display panel 6.

### TECHNICAL FIELD

The present invention relates to a display apparatus.

### BACKGROUND ART

Patent document 1 discloses display apparatus having a direct light type backlight. This display apparatus comprises a display panel, a diffusion plate positioned at the rear of the display panel, and a light source portion arranged at the rear of the diffusion plate. The display panel, the diffusion plate, and the light source portion are arranged inside a housing. The housing comprises a backlight chassis (back chassis) holding the light source portion, and a cabinet rear divided body arranged at the rear of the back chassis at a distance from the back chassis.

### PRIOR ART DOCUMENT

### Patent Document

Patent Document 1: WO2016/006025 A1

### SUMMARY OF THE INVENTION

### Problem to be Solved by the Invention

A display apparatus having a direct light type backlight such as the display apparatus disclosed in Patent Document 1 needs to be provided with a cabinet rear divided body outer to the back chassis, so that achieving a further thinning of the display apparatus having the direct light type backlight is not easy.

The problem to be solved by the present invention is further thinning of the display apparatus having the direct type backlight.

### Means to Solve the Problem

According to one aspect of the present invention, a display apparatus is provided, the display apparatus comprising a housing, a display panel, and a diffusion plate and a light source portion arranged at a region defined by the housing and the display panel, wherein the diffusion plate comprises a first surface facing a surface opposite to a display surface of the display panel, and a second surface being a surface opposite to the first surface; wherein the housing comprises a first portion provided with an aperture being blocked by the display panel and a second portion comprising an inner surface facing the second surface, the second portion being made of a resin, and the light source portion being arranged at the inner surface of the second portion; and wherein an outermost shell of the display apparatus is formed by the housing and the display panel.

### Effects of the Invention

The present invention makes it possible to achieve further thinning of a display apparatus having a direct light type backlight.

### BRIEF DESCRIPTION OF THE DRAWINGS

FIG. 1 shows a perspective view as viewed from the front of a liquid crystal display apparatus according to Embodiment 1 of the present invention.

FIG. 2 shows a perspective view as viewed from the rear of the liquid crystal display apparatus according to Embodiment 1 of the present invention.

FIG. 3 shows an exploded perspective view as viewed from the front of the liquid crystal display apparatus according to Embodiment 1 of the present invention.

FIG. 4 shows an exploded perspective view as viewed from the front of the liquid crystal display apparatus.

FIG. 5 shows an exploded perspective view as viewed from the rear of the liquid crystal display apparatus according to Embodiment 1 of the present invention.

FIG. 6 shows a cross-sectional view along a line V-V of FIG. 2.

FIG. 7 shows a cross-sectional view along a line VI-VI of FIG. 2.

FIG. 8 shows a cross-sectional view along a line VI-VI of FIG. 2.

FIG. 9 shows a cross-sectional view along a line VII-VII of FIG. 2.

FIG. 10 shows a cross-sectional view along a line VIII-VIII of FIG. 2.

FIG. 11 shows a partial cross-sectional perspective view as viewed from the front of a back chassis.

FIG. 12 shows a perspective view as viewed from the rear of the back chassis.

FIG. 13 shows an exploded perspective view as viewed from. the rear of the back chassis.

FIG. 14 shows a perspective view comprising a partial cross section as viewed from the rear of the back chassis.

FIG. 15 shows a perspective view as viewed from the front of an attaching plate.

FIG. 16 shows a perspective view as viewed from the rear of the attaching plate.

FIG. 17 shows an exploded perspective view as viewed from the front of a liquid crystal display apparatus according to Embodiment 2 of the present invention.

FIG. 18 shows a cross-sectional view of the liquid crystal display apparatus according to Embodiment 2 of the present invention.

FIG. 19 shows a cross-sectional view of the liquid crystal display apparatus according to Embodiment 2 of the present invention.

FIG. 20 shows an exploded perspective view as viewed from the front of a liquid crystal display apparatus according to Embodiment 3 of the present invention.

FIG. 21 shows a cross-sectional view of the liquid crystal display apparatus according to Embodiment 3 of the present invention.

FIG. 22 shows a cross-sectional view of the liquid crystal display apparatus according to Embodiment 3 of the present invention.

### EMBODIMENT FOR CARRYING OUT THE INVENTION

Embodiments of the present invention will be described below with reference to the attached drawings.

### Embodiment 1

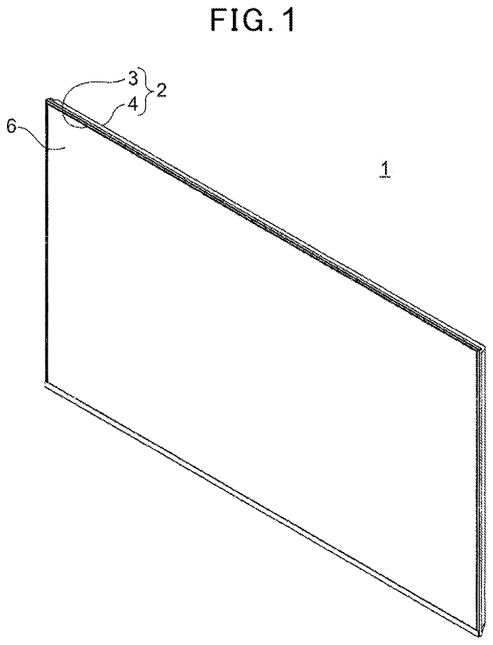

FIGS. 1 to 10 show a liquid crystal display apparatus having a direct light type backlight (one example of a display apparatus 1 according to Embodiment 1 of the present invention. In the description's below, the terms of “front”, “rear”, “up”, “down”, “left”, and “right”, and the terms similar thereto will be used based on a situation where the user faces a display surface of a liquid crystal panel 6 of the liquid crystal display apparatus 1 at the time of use thereof. More specifically, the orientation toward the user from the liquid crystal display apparatus 1 and the orientation in reverse thereof are called “front” and “rear”, respectively. These terms are used merely for ease of understanding and should not narrow the scope of the present invention in any sense.

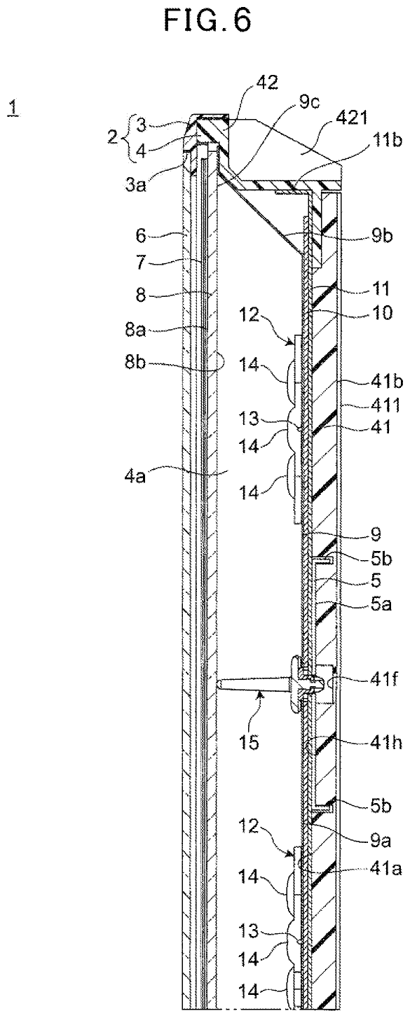

The liquid crystal display apparatus 1 comprises a housing 2 and a liquid crystal panel 6. As shown most clearly in FIGS. 6 to 9, the housing 2 comprises a bezel (one example of a first portion) 3 and a back chassis (one example of a second portion) 4. The housing 2 and the liquid crystal panel 6 form an outermost shell of the liquid crystal display apparatus 1. In other words, the liquid crystal display apparatus 1 does not comprise a member enclosing the housing 2 and the liquid crystal panel 6.

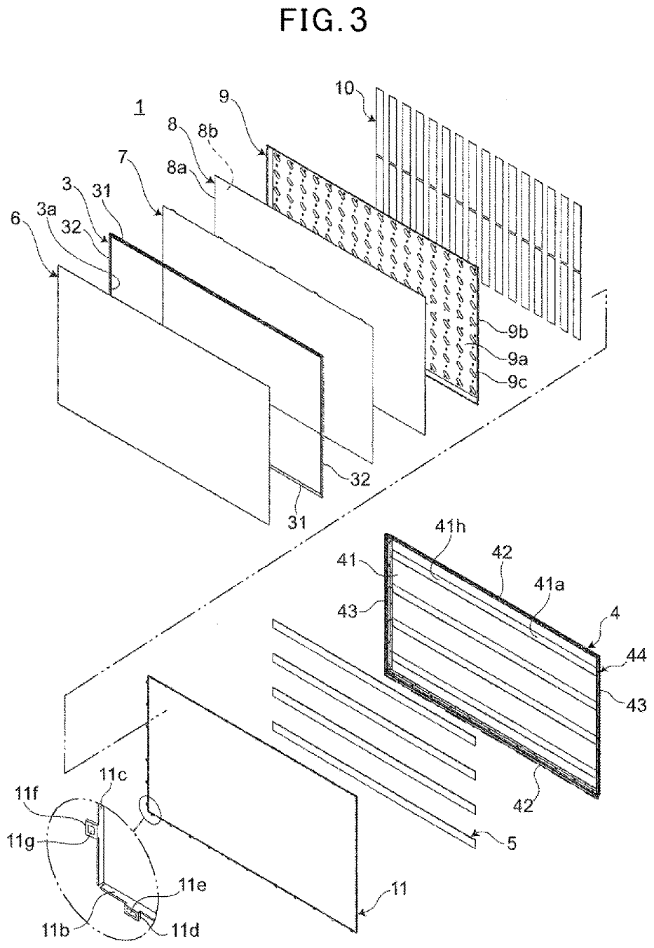

With reference to FIG. 3, the bezel 3 has a frame shape with a rectangular aperture 3a and comprises frame members 31 and 32 defining the aperture 3a. In the present Embodiment, the bezel 3 is made of a resin. The bezel 3 can be made of a non-resin material such as a metal.

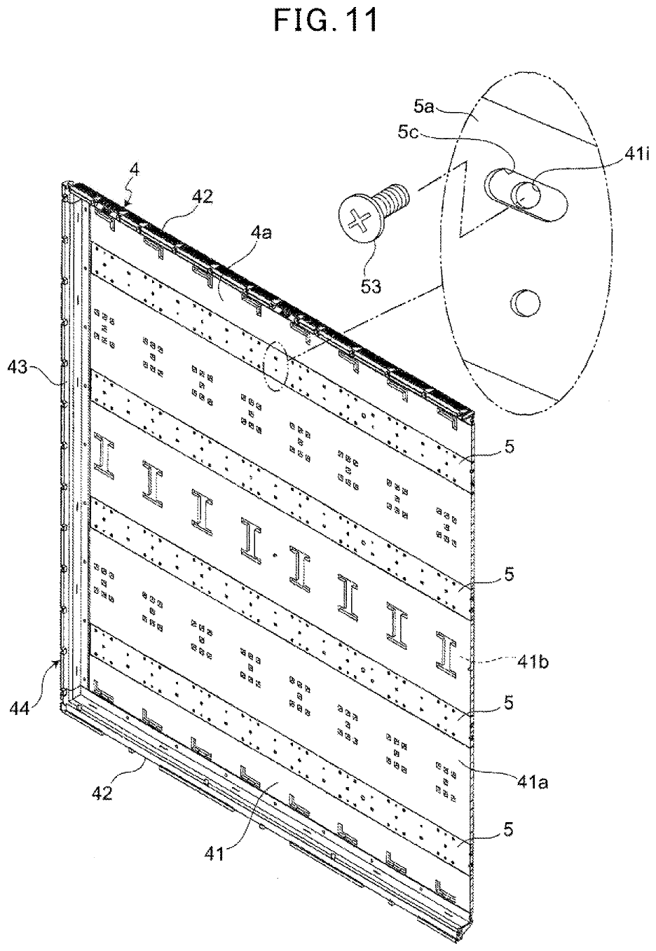

With reference to FIGS. 1 and 11, the back chassis 4 comprises a rectangular plate-shaped main body 41 and frame members 42 and 43 constituting a frame body 44 surrounding the peripheral edge of the main body 41. The back chassis 4 has a shape of a shallow box. The main body 41 comprises an inner surface 41a facing a rear surface 8b of a diffusion plate 8 to be described below and an outer surface 41b being a surface opposite to the inner surface 41a. A plurality (four according to the present Embodiment) of reinforcing plates (reinforcing members) 5 is attached to the inner surface 41a. Each of the main body 41 and the frame body 44 of the back chassis 4 can be made of a general resin. In the present Embodiment, each of the main body 41 and the frame body 44 is made of a resin having high thermal conductivity, such as a highly heat dissipating resin (a resin in which powder of carbon or a metal (aluminum/copper, etc.) is mixed). The frame body 44 can be made of a non-resin material (for example, a metal). In the present Embodiment, the reinforcing plates 5 are made of a metal. Details of the back chassis 4 and the reinforcing plates 5 will be described later.

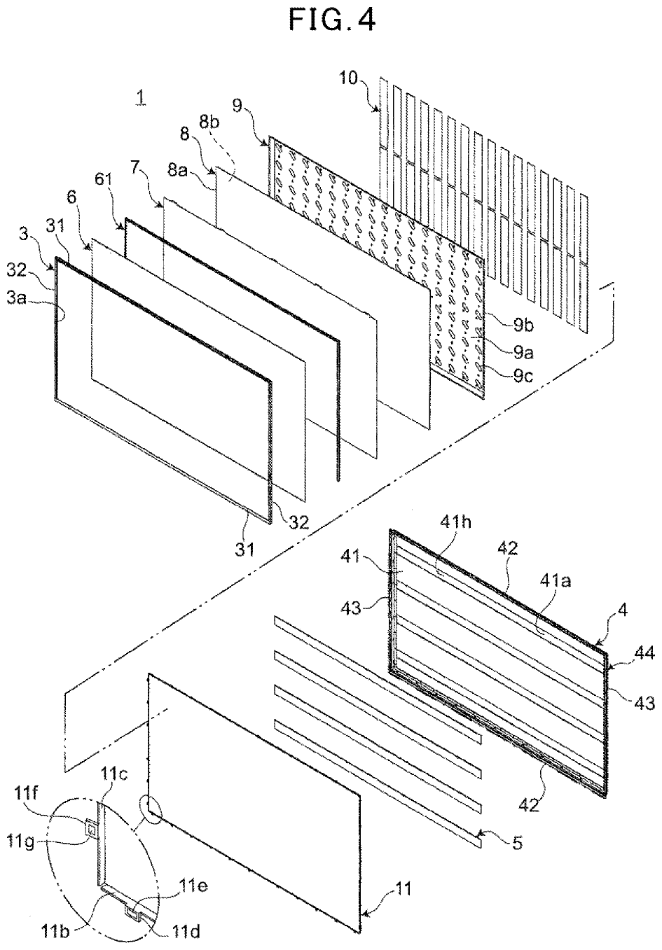

As shown most clearly in FIGS. 3 and 4, a space defined by the bezel 3, the back chassis 4, and the liquid crystal panel 6 is formed inside the housing 2 and the liquid crystal panel (one example of a display panel) 6. An optical sheet 7, the diffusion plate 8, a reflection sheet 9, a plurality of light source substrates 10, and an attaching plate (one example of an attaching member) 11 are housed in the above-mentioned space. The light source substrates 10, together with an LED assembly 12 to be described below, constitutes a light source portion. Below, with mainly reference to FIGS. 6 to 9, an arrangement of these elements will be further described.

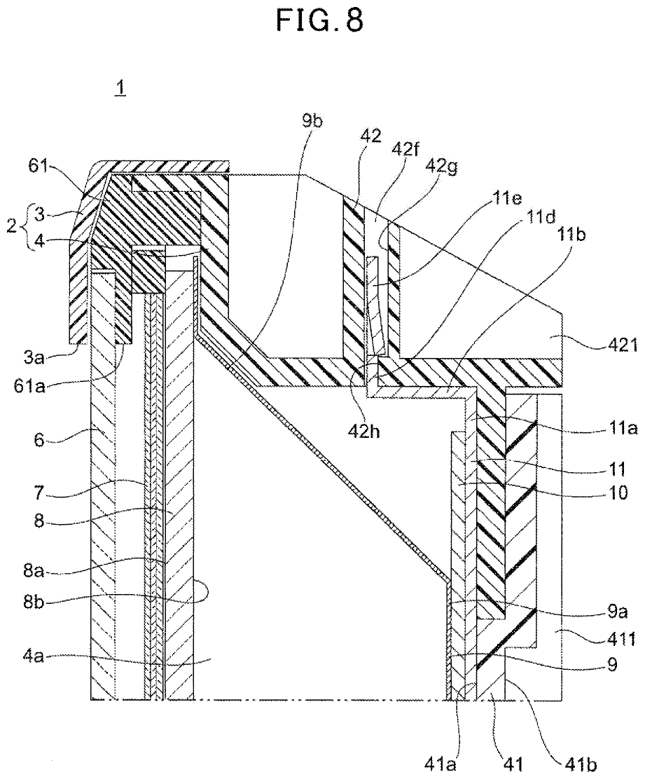

The liquid crystal panel 6 is arranged so as to close the aperture 3a of the bezel 3. For example, as shown in FIG. 8, the rear surface of the liquid crystal panel 6 can be bonded to the front surface of the bezel 3 to close the aperture 3a of the bezel 3 by the rear surface of the liquid crystal panel 6. Alternatively, as shown in FIG. 4, the rear surface of the bezel 3 can come into contact with the front surface of the liquid crystal panel 6 to close the aperture 3a of the bezel 3 by the front surface of the liquid crystal panel 6.

In FIGS. 4 and 8, the rear surface of the liquid crystal panel 6 comes into contact with the front surface of a frame (panel chassis) 61 to close an aperture 61a of the frame 61 and the liquid crystal panel 6 is sandwiched by the rear surface of the bezel 3 and the front surface of the frame 61.

The frame 61 can have a frame shape in which the rectangular aperture 61a is formed in a manner similar to the bezel 3, or the frame 61 can consist of three sides defining the aperture 61a. FIG. 4 shows the frame 61 consisting of three sides, lacking one side, the one side being the lower one side in FIG. 4. In this case, the back chassis 4 has the function instead of the function of the lacking one side. In the present Embodiment, while the frame 61 is made of a resin, it can be made of a non-resin material.

The optical sheet 7 is arranged adjacent to the liquid crystal panel 6 at the rear of the liquid crystal panel 6. The diffusion plate 8 is arranged adjacent to the optical sheet 7 at the rear of the optical sheet 7. The diffusion plate 8 comprises a front surface (a first surface) 8a facing a surface opposite to the display surface of the display panel 6, and a rear surface (a second surface) 8b being a surface opposite to the front surface 8a. The reflection sheet 9 is arranged at the rear of the diffusion plate 8. The reflection sheet 9 comprises a rectangular-plate shaped flat portion 9a and an inclined portion 9b upstanding from the peripheral edge of the flat portion 9a. The diffusion plate 8 is arranged such that the diffusion plate 8 closes an aperture 4a opening frontward of the back chassis 4.

The light source substrates 10 is arranged adjacent to the flat portion 9a at the rear of the flat portion 9a. LED assembly units 12 are mounted to the light source substrates 10. Each of the LED assembly units 12 comprises a plurality of LEDs (one example of a light source) 13 and a plurality of lenses 14 corresponding to the respective plurality of LEDs 13. Each of the LED assembly units 12 is arranged such that it passes through a window hole 9c (also see FIG. 3) formed at the flat portion 9a of the reflection sheet 9 and has the optical axis of the LEDs 13 oriented to the rear surface 8b of the diffusion plate 8.

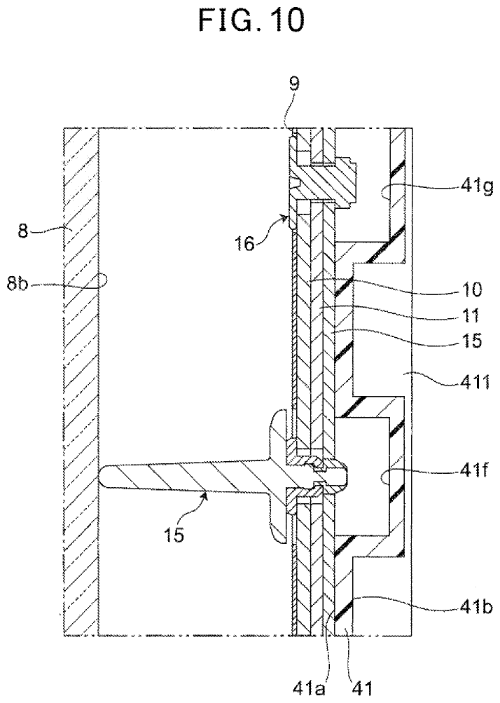

The attaching plate 11 is arranged adjacent to the light source substrates 10 at the rear of the light source substrates 10. With reference to also FIGS. 3, 15, and 16, the attaching plate 11 comprises a rectangular plate-shaped flat plate portion 11a arranged at the inner surface 41a of the main body 41 of the back chassis 4, and peripheral walls 11b and 11c upstanding from the peripheral edge of the flat plate portion 11a. The light source substrates 10 are fixed to the flat plate portion 11a by clips 15, 16 (also see FIG. 10). The flat plate portion 11a of the attaching plate 11 is arranged adjacent to the inner surface 41a of the main body 41 of the back chassis 4. As described in detail later, the attaching plate 11 is fixed to the back chassis 4. The light source substrates 10 are fixed to the flat plate portion 11a. Therefore, the light source substrates 10 are arranged at the inner surface 41a of the main body 41 of the back chassis 4 via the flat plate portion 11a. In the present Embodiment, the attaching plate 11 is made of a metal.

As described previously, the housing 2 and the liquid crystal panel 6 form the outermost shell of the liquid crystal display apparatus 1. The liquid crystal display apparatus 1 does not comprise a member (for example, a cabinet rear divided body) further covering the entirety of the back chassis 4, making it possible to realize thinning of the liquid crystal display apparatus 1. The light source substrates 10 are arranged at the inner surface 41a of the main body 41 of the back chassis 4 and, as described previously, the back chassis 4 is made of a resin having high thermal conductivity.

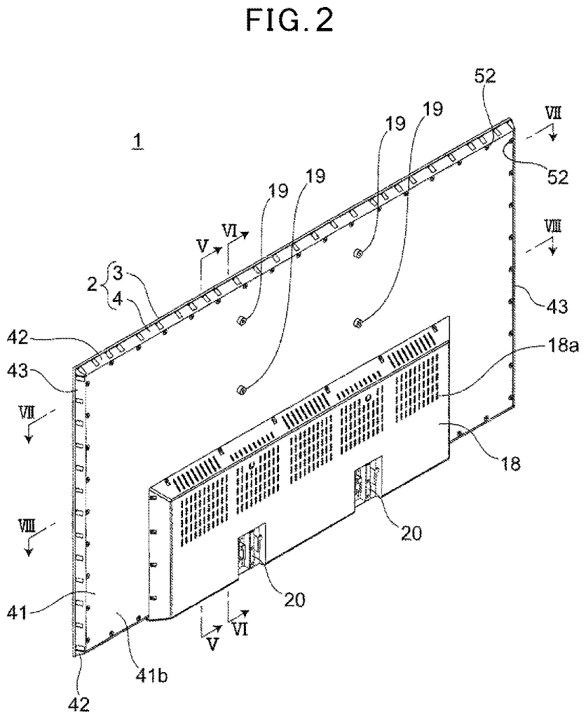

Next, with mainly reference to FIGS. 2, 5, and 11 to 14, details of the back chassis 4 and the reinforcing plates 5 will be described.

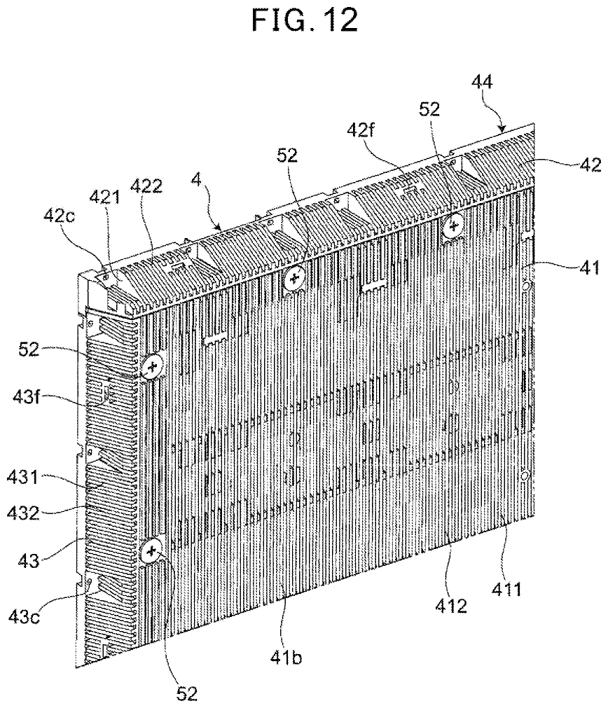

As shown most clearly in FIGS. 12 to 14, the back chassis 4 is provided with a structure to conduct forced air cooling over the substantial entirety of the back chassis 4. More specifically, a structure to conduct forced air cooling is provided in the outer surface 41b of the main body 41 of the back chassis 4 over the substantial entirety of the outer surface 41b. More specifically, a large number of fins (heat dissipating ribs) 411 provided at an interval protrude toward the rear and extend toward the vertical direction (up-down direction shown) at the time of use. Grooves 412 are defined in between the neighboring fins 411. Similarly, also on the frame members 42, 43 of the back chassis 4, a large number of fins 421, 431 are provided at an interval, respectively, and the fins 421, 431 are protruding toward the rear over the entirety of the respective longitudinal direction of the frame members 42, 43 and extending along the respective short direction of the frame members 42, 43. Grooves 422, 432 are defined in between the neighboring fins 421, 431, respectively.

The surface area of the outer surface 41b of the main body 41 of the back chassis 4 is drastically increased by the fins 411 compared to the case in which the outer surface 41b is merely a flat surface. Moreover, also the surface area of the frame body 44 (the frame members 42, 43) is drastically increased by the fins 421, 431. The fins 411, 421, 431 being provided over the substantial entirety of the back chassis 4 caused the back chassis 4 to be cooled to the extent beyond expectations even at the time of operation of the liquid crystal display apparatus 1.

Moreover, as shown, the fins 411 extending in the up-down direction cause air in the vicinity of the outer surface 41b to be warmed up and expand by heat dissipated from the outer surface 41b. Buoyancy causes expanded air to rise in the groove 412, causing cool air in the surrounding to flow in toward the fins 411. Such flow of air causes warmed up air and cool air to be exchanged. Therefore, the back chassis 4 is cooled more effectively and receives heat inside the housing 2 effectively.

The outer surface 41b of the main body 41 of the back chassis 4 having the features as described above makes it possible to dissipate heat generated inside the housing 2 out of the housing 2.

Normally, the chimney effect taking place in the space between the back chassis and the cabinet rear divided body causes the liquid crystal display apparatus having the direct light type backlight to dissipate heat within the housing out of the housing. According to the present Embodiment, the above-described back chassis 4 can realize heat dissipation to the extent such that the chimney effect is not needed. Therefore, the liquid crystal display apparatus 1 according to the present Embodiment does not require the cabinet rear divided body, thus making it possible to realize further thinning.

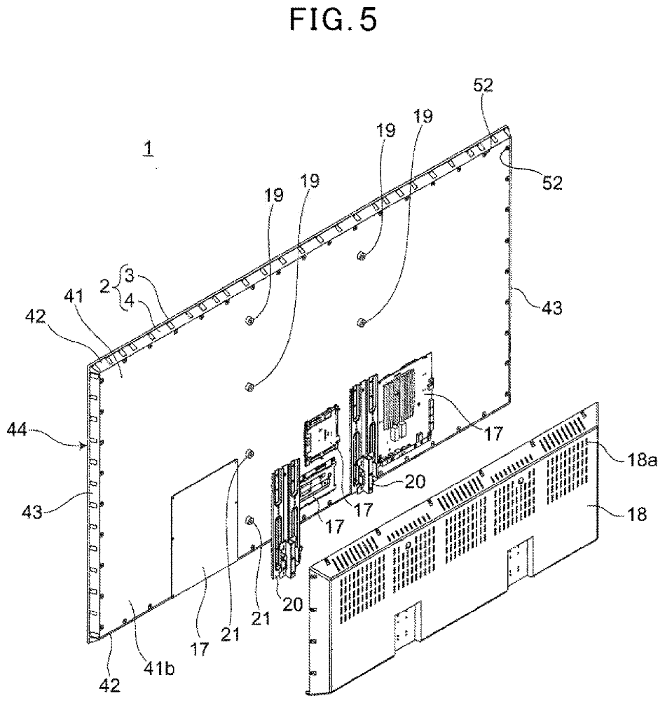

With reference to FIGS. 2 and 5, a plurality of circuit substrates 17 are fixed to the outer surface 41b of the main body 41 of the back chassis 4. These circuit substrates 17 are provided with various circuits such as a drive circuit for the liquid crystal panel 6, and a power supply circuit. A cover 18 for protecting the circuit substrates 17 is fixed to the outer surface 41b of the main body 41 of the back chassis 4. A plurality of slits 18a are formed at the cover 18 to maintain ventilation in and out of the cover 18 to promote dissipation of heat generated in the circuit substrates 17. In this way, the cover 18 is neither a member covering the entirety of the back chassis 4 such as the cabinet rear divided body nor a member to cause heat within the housing to be dissipated out of the housing.

With continuing reference to FIGS. 2 and 5, studs 19 for hanging the liquid crystal display apparatus 1 on a wall surface are provided in the outer surface 41b of the main body 41 of the back chassis 4. These studs 19 are fixed to the reinforcing plates 5 made of a metal. Moreover, brackets 20 made of a metal are provided in the outer surface 41b of the main body 41 of the back chassis 4 to attach a desktop stand (not shown.). These brackets 20 are fixed to the outer surface 41b by studs 21 provided in the outer surface 41b of the main body 41, and the studs 21 are fixed to the reinforcing plates 5.

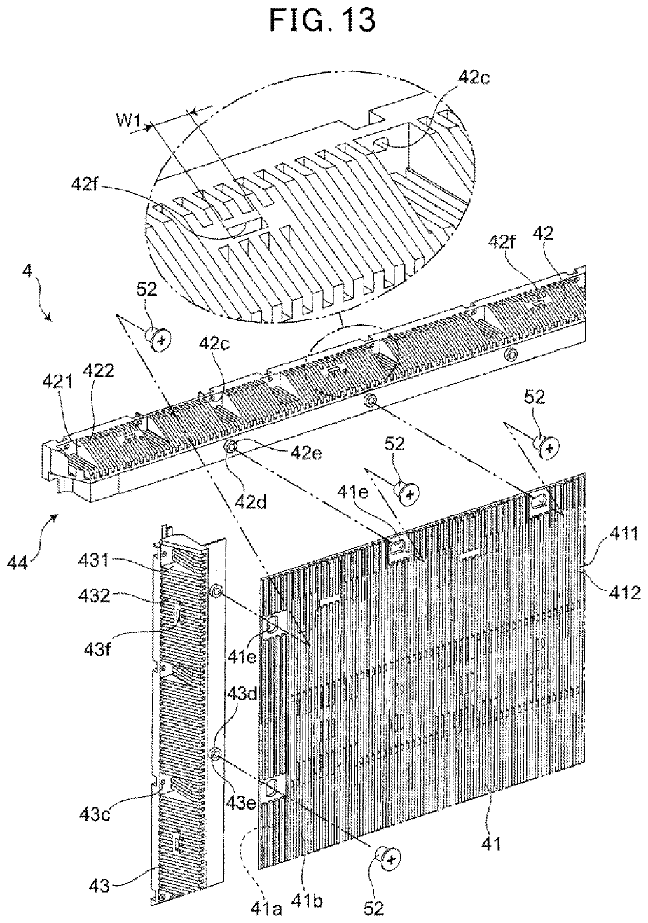

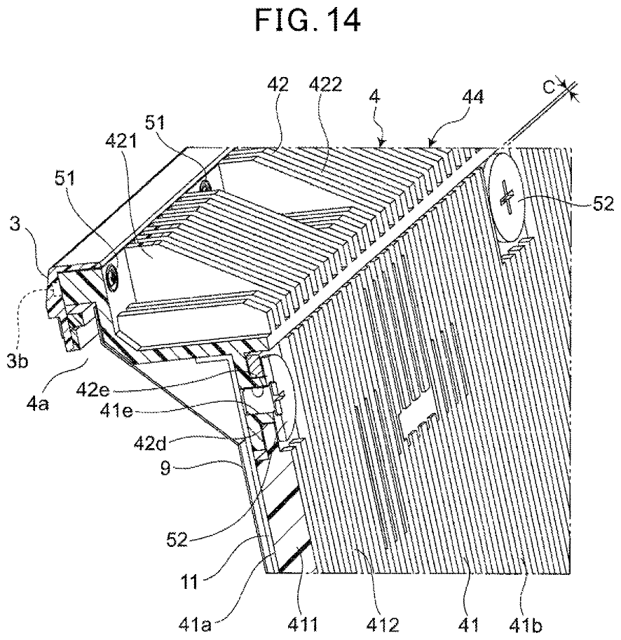

With reference to FIG. 14, a plurality of screw holes (first screw holes) 3b is provided in the rear side surface of the bezel 3. Moreover, with reference to FIG. 13, long holes (first long holes) 42c, 43c penetrating in the thickness direction are formed at a position corresponding to the screw hole 3b at the frame members 42, 43 of the back chassis 4. The tip of a screw (first screw) 51 inserted into the long holes 42c, 43c is screwed into the screw hole 3b to connect the bezel 3 to the frame members 42, 43 of the back chassis 4. In this way, the bezel 3 and the back chassis 4 constituting the housing 2 are connected by the screw 51.

The long hole 42c formed at the frame member 42 has a shape extending in the longitudinal direction (left-right direction shown) of the frame member 42. Therefore, if the back chassis 4 thermally expands or shrinks in the left-right direction, the constraint of thermal expansion or shrinkage due to the screw 51 interfering with an end portion of the long hole 42c does not occur until the amount of expansion or shrinkage increases to some extent. In other words, connection of the bezel 3 and the back chassis 4 by the screw 51 allows, to some extent, thermal expansion and shrinkage in the left-right direction of the back chassis 4. The long hole 43c formed at the frame member 43 has a shape extending in the longitudinal direction (up-down direction shown) of the frame member 43. Therefore, if the back chassis 4 thermally expands or shrinks in the up-down direction, the constraint of thermal expansion or shrinkage due to the screw 51 interfering with an end portion of the long hole 43c does not occur until the amount of expansion or shrinkage increases to some extent. In other words, connection of the bezel 3 and the back chassis 4 by the screw 51 allows, to some extent, thermal expansion and shrinkage in the up-down direction of the back chassis 4.

In this way, connection of the bezel 3 and the back chassis 4 by the screw 51 allows, to some extent, thermal expansion and shrinkage in the up-down direction and left-right direction of the back chassis 4 by the long holes 42c, 43c formed at the frame members 42 and 43, respectively. As a result, deformation such as warpage of the back chassis 4 caused by thermal expansion or shrinkage of the main body 41 can be prevented or suppressed.

The connection of the bezel 3 and the back chassis 4 by the screw 51 can also be realized by providing the bezel 3 with a long hole and providing the back chassis 4 with a screw hole.

With reference to FIGS. 12 to 14, the main body 41 and the frame body 44 of the back chassis 4 are connected by a screw (second screw hole) 52 with the frame body 44 being arranged onto the inner surface 41a of the main body 41. As shown conceptually with a letter C in FIG. 14, a gap is provided between the frame body 44 and the peripheral edge of the main body 41.

Connection of the main body 41 and the frame member 42 by the screw 52 will be described. A plurality of cylindrical portions 42d protruding rearward are formed at the frame member 42, and each of the cylindrical portions 42d is provided with a screw hole (second screw hole) 42e. Moreover, a long hole (second long hole) 41e is formed at the main body 41. The long hole 41e has a shape extending in the direction (left-right direction) along the horizontal direction at the time of use and penetrates in the thickness direction at a position corresponding to each of the cylindrical portions 42d (in other words, a position corresponding to each of the screw holes 42e). The cylindrical portion 42d is inserted into the long hole 41e and the tip of the screw 52 (second screw) is screwed into the screw hole 42e, in other words, the tip of the screw 52 inserted into the long hole 41e is screwed into the screw hole 42e to connect the main body 41 and the frame member 42.

The dimension in the short direction of the long hole 41e is set to be slightly greater than the outer diameter of the cylindrical portion 42d to an extent such that a minimum gap needed for inserting the cylindrical portion 42d into the long hole 41e is maintained. The dimension in the longitudinal direction of the long hole 41e is set to be sufficiently greater than the outer diameter of the cylindrical portion 42d. Connection of the main body 41 and the frame member 43 by the screw 52 is the same as the connection of the main body 41 and the frame member 42, except for the long hole 41 e formed at the main body 41 having a shape extending in the up-down direction. In other words, the cylindrical portion 43d of the left frame member 43 is inserted into the long hole 41e and the tip of the screw 52 is screwed into the screw hole 43e to connect the main body 41 and the frame member 43.

A gap C is provided between the main body 41 and the frame body 44. Moreover, the long holes 41e for connecting the main body 41 to the frame member 42 among the long holes 41e formed at the main body 41 each have a shape extending in the left-right direction. Thus, if the main body 41 thermally shrinks in the left-right direction, the constraint of thermal shrinkage due to the screw 52 interfering with an end portion of the long hole 41e does not occur until the amount of shrinkage increases to some extent. Moreover, if the main body 41 thermally expands, the constraint of thermal expansion due to the main body 41 interfering with the frame body 44 does not occur until the amount of expansion reaches the dimension of the gap C. In other words, connection of the main body 41 and the frame member 42 by the screw 52 allows, to some extent, thermal expansion and shrinkage in the left-right direction of the main body 41. Moreover, the long holes 41e for connecting the main body 41 to the frame member 43 among the long holes 41e formed at the main body 41 each have a shape extending in the up-down direction. Therefore, if the main body 41 thermally expands or shrinks in the up-down direction, the constraint of thermal expansion or shrinkage due to the screw 52 interfering with an end portion of the long hole 42e does not occur until the amount of expansion or shrinkage increases to some extent. In other words, connection of the main body 41 and the frame member 43 by the screw 52 allows, to some extent, thermal expansion and shrinkage in the up-down direction of the main body 41.

In this way, providing a gap C between the main body 41 and the frame body 44 as well as forming a long hole 41e at the main body 41 for connecting the main body 41 and the frame body 44 by the screw 52 allows, to some extent, thermal expansion and shrinkage in the up-down direction and the left-right direction of the main body 41. As a result, deformation such as warpage of the main body 41 caused by thermal expansion or shrinkage can be prevented or suppressed.

Connection of the main body 41 and the frame body 44 by the screw 52 can also be realized by providing the frame members 42, 43 with a long hole and providing the main body 41 with a screw hole.

With reference to FIGS. 6 and 10, recessed portions 41f, 41g for accommodating rear end portions of the clips 15, 16 are formed at the inner surface 41a of the main body 41. With these recessed portions 41f, 41g, the clips 15, 16 do not protrude toward the rear of the outer surface 41b of the main body 41.

With reference to FIG. 11, the reinforcing plates 5 made of a metal are attached to the inner surface 41a of the main body 41 of the back chassis 4. With reference also to FIG. 6, the reinforcing plates 5 according to the present Embodiment comprise an elongated rectangular-shaped flat plate portion 5a, and folded portions 5b provided along a pair of long sides of the flat plate portion 5a. The reinforcing plates 5 are attached to the back chassis 4 such that the longitudinal direction thereof extends along the horizontal direction at the time of use. A recessed portion 41h for accommodating the reinforcing plate 5 is formed at the inner surface 41a of the main body 41 of the back chassis 4. The inner surface 41a of the main body 41 of the back chassis 4 is flush with the inner surface of the flat plate portion 5a of the reinforcing plate 5.

With continuing reference to FIG. 11, the main body 41 of the back chassis 4 is provided with screw holes (third screw holes) 41i. Moreover, a long hole (third long hole) 5c is formed at the flat plate portion 5a of the reinforcing plate 5 such that it penetrates the flat plate portion 5a in the thickness direction. The tip of a screw 53 (third screw) inserted into the long hole 5c is screwed into the screw hole 41i to attach the reinforcing plate 5 to the main body 41 of the back chassis 4. In this way, the reinforcing plate 5 is attached to the inner surface 41a of the main body 41 of the back chassis 4 by the screw 53.

The long hole 5c formed at the flat plate portion 5a of the reinforcing plate 5 has a shape extending in the left-right direction. While the reinforcing plate 5 made of a metal has a greater thermal expansion coefficient than that of the main body 41 of the back chassis 4 being made of a resin, the difference in the amount of thermal expansion or shrinkage caused by the difference in the thermal expansion coefficient between the reinforcing plate 5 and the main body 41 is absorbed by the long hole 5c to some extent. As a result, an occurrence of deformation such as warpage of the main body 41 of the back chassis 4 caused by thermal expansion or shrinkage of the reinforcing plate 5 can be prevented or suppressed. In this way, attachment of the reinforcing plate 5 to the main body 41 of the back chassis 4 by the screw 53 allows, to some extent, thermal expansion and/or shrinkage in the left-right direction of the reinforcing plate 5.

Next, with primary reference to FIGS. 3, 7, 9, 15, and 16, a structure for fixing the attaching plate 11 to the back chassis 4 will be described.

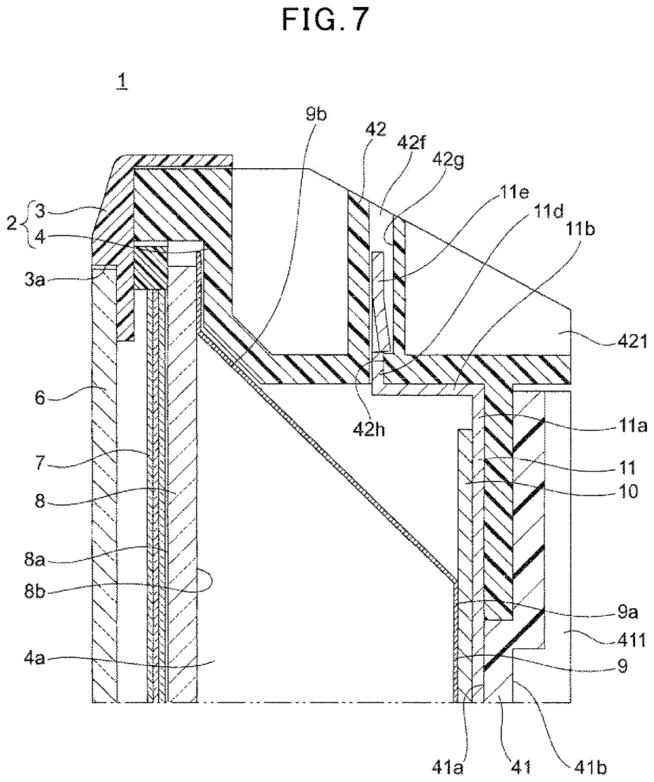

With reference to FIGS. 7 and 13, a plurality of engaging holes 42f are formed at the frame member 42 of the back chassis 4. The engaging holes 42f are slit-shaped through holes penetrating the frame member 42 in the up-down direction. A stepped portion 42h is formed at the hole wall 42g of this engaging hole 42f. With reference also to FIGS. 3, 15, and 16, tab-like portions 11d are provided in the peripheral wall 11b of the attaching plate 11, each of the tab-like portions 11d protrude in the up-down direction at a position corresponding to each of the engaging hole 42f. An engaging piece 11e elastically bendable is formed at the individual tab-like portion 11d by cutting arid raising thereof. As shown in FIG. 7, the tab-like portion 11d is inserted into the engaging hole 42f of the upper and lower frame members 42 and the engaging piece 11e engages the stepped portion 42h. This engagement attaches the attaching plate 11 to the back chassis 4.

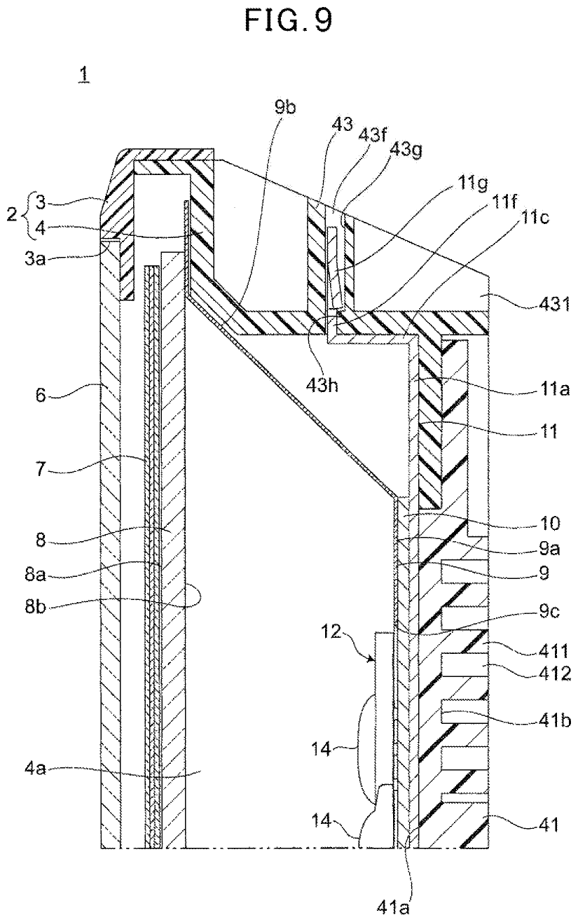

With reference to FIGS. 9 and 13, a plurality of engaging holes 43f are formed at the frame member 43 of the back chassis 4. The engaging holes 43f are slit-shaped through holes penetrating the frame member 43 in the front-rear direction. A stepped portion 43h is formed at the hole wall 43g of the engaging hole 43f. With reference also to FIGS. 3, 15, and 16, tab-like portions 11f are provided in the peripheral wall 11c of the attaching plate 11, each of the tab-like portions 11f protrude in the left-right direction at a position corresponding to each of the engaging hole 43f. An engaging piece 11g elastically bendable is formed at the individual tab-like portion 11f by cutting and raising thereof. As shown in FIG. 9, the tab-like portion 11f is inserted into the engaging hole 43f of the frame member 43 and the engaging piece 11g engages the stepped portion 43h. This engagement attaches the attaching plate 11 to the back chassis 4.

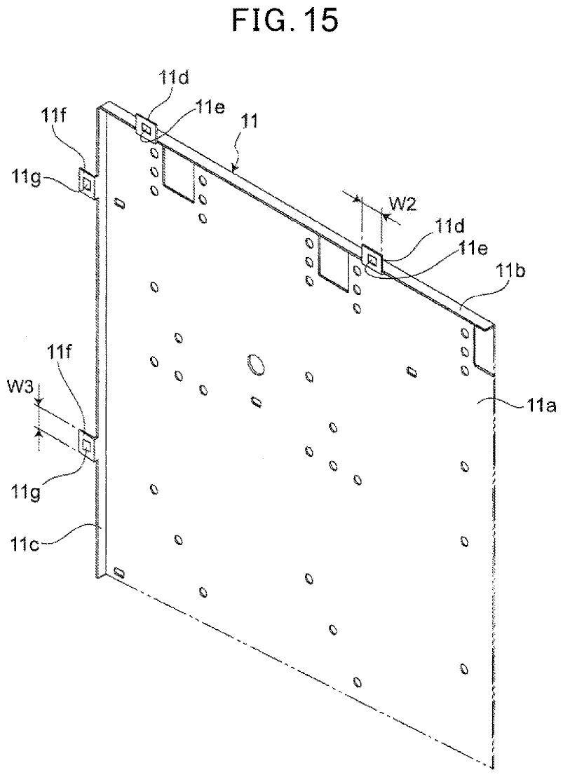

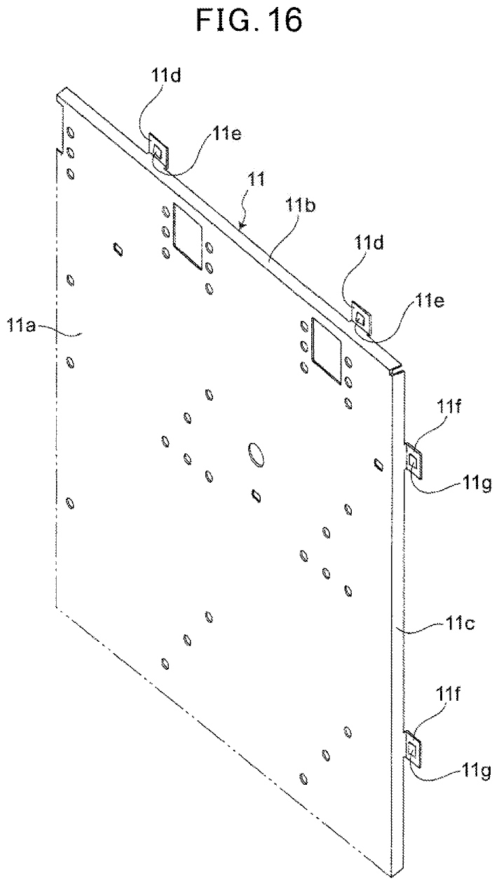

The width of the engaging hole 42f being indicated with a letter W1 in FIG. 13 is set to be greater than the width of the tab-like portion lid being indicated with a letter W2 in FIGS. 15 and 16. Moreover, the width of the engaging hole 43f is set to be greater than the width of the tab-like portion 11f being indicated with a letter W3 in FIGS. 15 and 16. While the attaching plate 11 made of a metal has a greater thermal expansion coefficient than that of the main body 41 of the back chassis 4 being made of a resin, the difference in the amount of thermal expansion or shrinkage caused by this difference in the thermal expansion coefficient is absorbed, to some extent, by the dimensional difference between the width W1 of the engaging holes 42f, 43f and the widths W2, W3 of the tab-like portions 11d, 11f. As a result, an occurrence of deformation such as warpage of the main body 41 of the back chassis 4 caused by thermal expansion or shrinkage of the attaching plate 11 can be prevented or suppressed. In this way, fixing of the attaching plate 11 to the back chassis 4 by the engaging holes 42f, 43f and the engaging pieces 11e, 11g allows, to some extent, thermal expansion and/or shrinkage in the up-down direction and the left-right direction of the attaching plate 11.

For Embodiments 2 and 3 below, structures and functions not mentioned in particular are the same as for Embodiment 1. Moreover, in the drawings of these Embodiments, the same letter is affixed for the same element in Embodiment 1.

### Embodiment 2

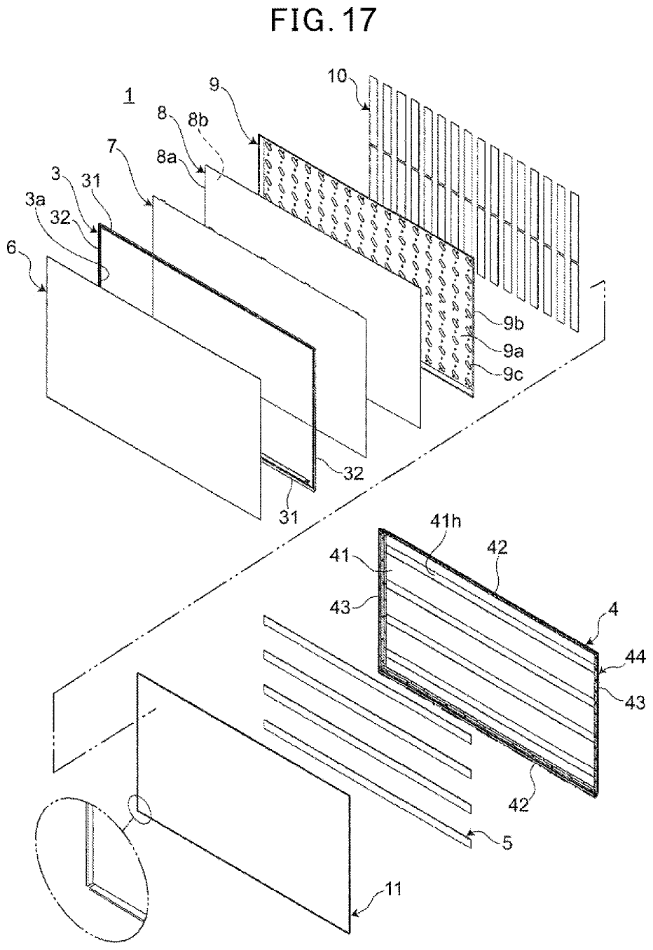

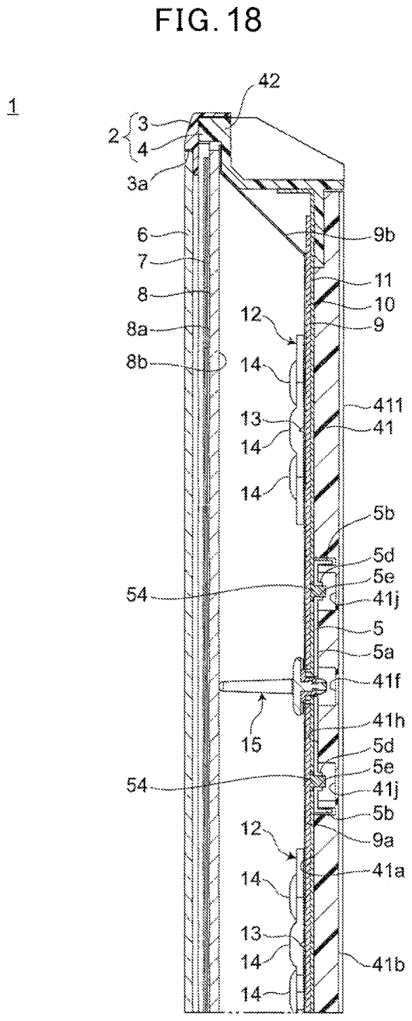

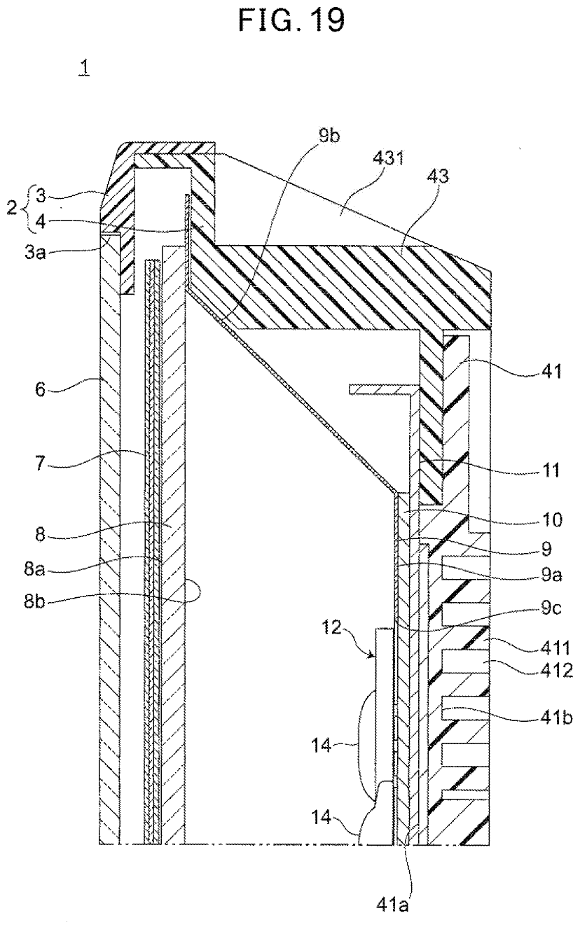

FIGS. 17 to 19 show a liquid crystal display apparatus 1 according to Embodiment 2 of the present invention. According to a liquid crystal display apparatus 1 of the present Embodiment, an attaching plate 11 does not comprise the tab-like portion 11d, 11f (see FIGS. 3, 7, and 9, etc.). The attaching plate 11 is fixed to an inner surface 41a of a main body 41 of a back chassis 4 by a screw 54. More specifically, a reinforcing plate 5 has a screw hole 5e formed at a burring portion 5d, and the screw 54 is screwed into the screw hole 5e to fix the attaching plate 11 to the reinforcing plate 5. A recessed portion 41j is provided in the inner surface 41a of the main body 41 of the back chassis 4, and a burring portion 5d is accommodated in the recessed portion 41j. Therefore, the tip of the screw 54 does riot protrude from an outer surface 41b of the main body 41 of the back chassis 4.

### Embodiment 3

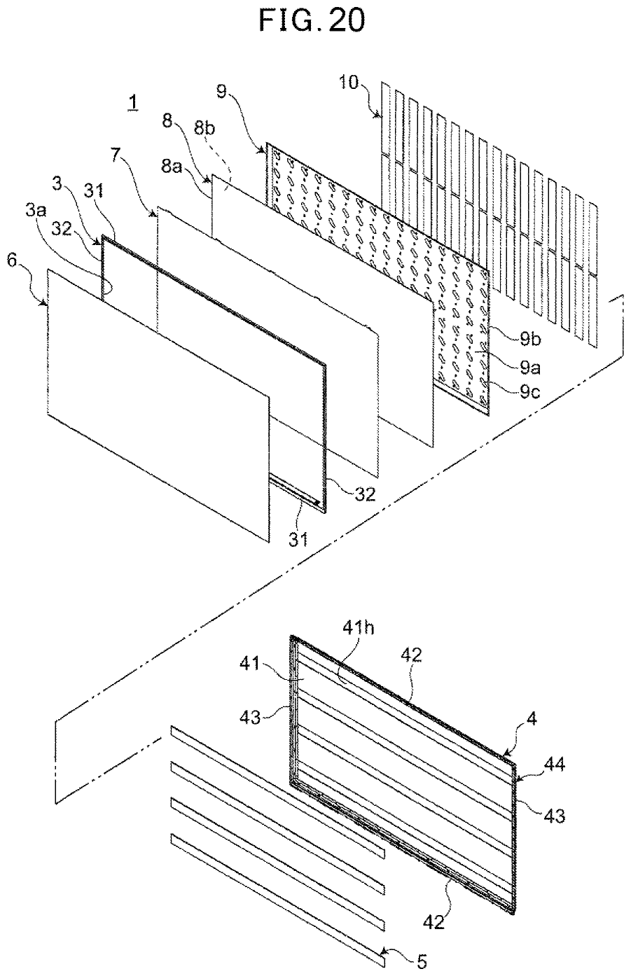

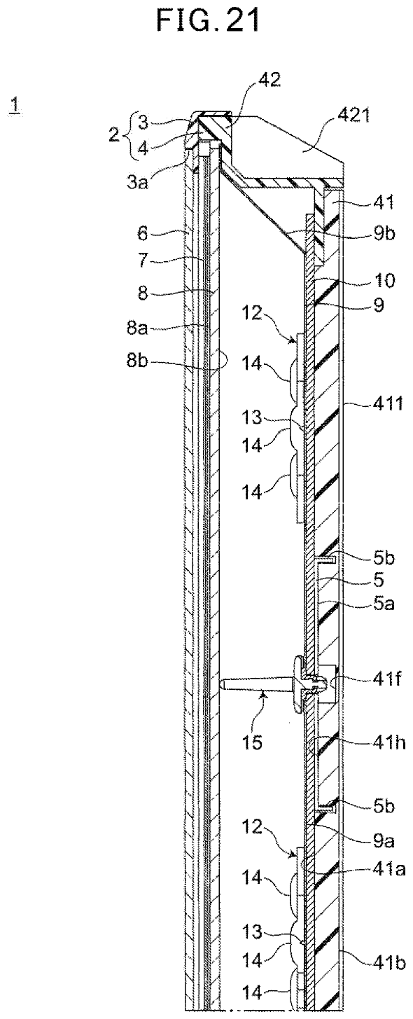

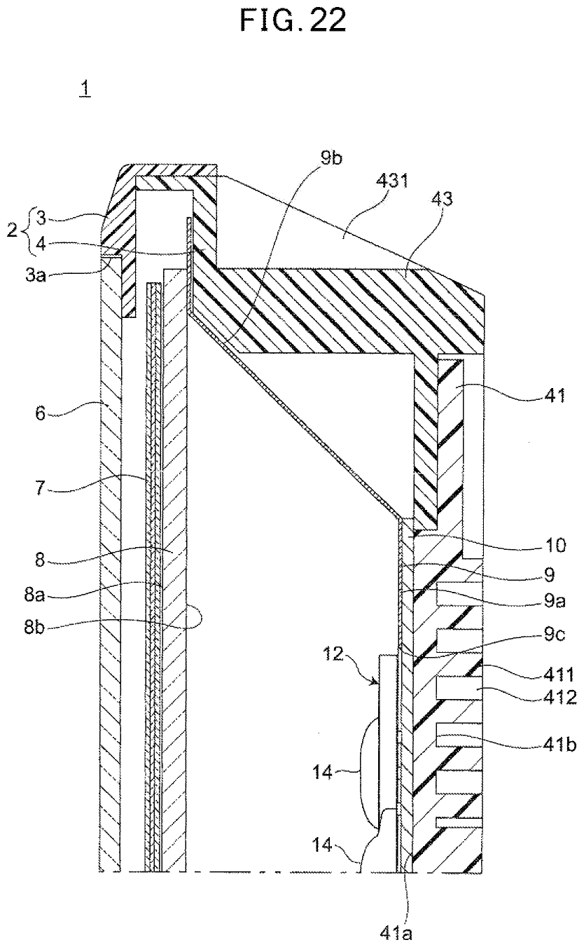

FIGS. 20 to 22 show a liquid crystal display apparatus 1 according to Embodiment 3 of the present invention. The liquid crystal display apparatus 1 according to the present Embodiment does not comprise the attaching plate 11 (see FIGS. 15 and 16, etc.), and a light source substrate 10 is fixed to a reinforcing plate 5 by clips 15 and 16.

Preferred Embodiments of the present invention are shown below.

A display apparatus according to one aspect of the present invention comprises a housing, a display panel, a diffusion plate arranged at a region defined by the housing and the display panel, and a light source portion arranged at the region defined by the housing and the display panel, wherein the diffusion plate has a first surface facing a surface opposite to a display surface of the display panel, and a second surface being a surface opposite to the first surface, wherein the housing comprises a first part having an aperture being closed by the display panel and a second part having an inner surface facing the second surface, the second part being made of a resin, and the light source portion being arranged at the inner surface of the second portion, and wherein an outermost shell of the display apparatus is formed by the housing and the display panel.

The inner surface of the second part of the housing faces the second surface of the diffusion plate, and the light source portion is arranged at the inner surface of the second part. In this way, the display apparatus is a display apparatus having a direct light type backlight. The housing comprising the second part having the inner surface at which the light source portion is arranged constitutes the outermost shell of the display apparatus together with the display panel. Therefore, the display apparatus does not require a cabinet rear divided body provided in the display apparatus having a direct light type backlight. Accordingly, further thinning of the display apparatus can be realized.

A plurality of fins can be provided in an outer surface of the second portion, the plurality of fins being oriented in one direction.

The light source portion is arranged at the inner surface of the second portion being a portion of the housing constituting the outermost shell of the display apparatus. While the second portion is made of a resin, the fins can be provided in the second part to improve the property of dissipating heat generated in the light source portion. Moreover, a highly heat dissipating resin (a resin in which powder of carbon or a metal such as aluminum/copper, etc. is mixed) can be used to further improve the property of dissipating heat generated in the light source portion.

One of the first part and the second part can have a first long hole and the other of the first part and the second part can have a first screw hole, and a tip of a first screw inserted into the first long hole can be screwed into the first screw hole to connect the first part and the second part.

This configuration makes it possible to prevent or suppress deformation of the first part, the deformation being caused by thermal expansion or shrinkage.

The second part can comprise a main body comprising the inner surface and a frame body surrounding a peripheral edge of the main body, one of the main body and the frame body can have a second long hole and the other of the main body and the frame body can have a second screw hole, and the a of the second screw inserted into the second long hole can be screwed into the second screw hole to connect the main body and the frame body.

This configuration makes it possible to prevent or suppress deformation of the main body of the first part, the deformation being caused by thermal expansion or shrinkage.

The display apparatus can further comprise a reinforcing member attached to the inner surface of the second part.

The above-described configuration makes it possible to improve the strength of the second part.

The reinforcing member can have a third long hole and the first part can have a third screw hole, and a tip of a third screw inserted into the third long hole can be screwed into the third screw hole to attach the reinforcing member to an inner surface of the first part.

This configuration allows, to some extent, thermal expansion and shrinkage of the reinforcing member in the longitudinal direction of the third long hole.

The display apparatus can further comprise an attaching member arranged at the inner surface of the second part, and the light source portion can be fixed to the attaching member.

More specifically, the attaching member can comprise an engaging piece, and the engaging piece can engage a hole wall of an engaging hole provided in the second part to fix the attaching member to the second part.

This configuration allows thermal expansion and shrinkage of the attaching plate.

Alternatively, the attaching member can be fixed to the second part by screwing.

The light source portion can be fixed to the inner surface of the second part.

### DESCRIPTION OF REFERENCE NUMERALS

1 Liquid crystal display apparatus
2 Housing
3 Bezel
3a Aperture
3b Screw hole (first screw hole)
4 Back chassis
4a Aperture
5 Reinforcing plate
5a Fiat plate portion
5b Folded portion
5c Long hole (third long hole)
5d Burring portion
5e Screw hole
6 Liquid crystal panel
7 Optical sheet
8 Diffusion plate
8a Front surface
8b Rear surface
9 Reflection sheet
9a Flat portion
9b Peripheral wall
9c Window hole
10 Light source substrate
11 Attaching plate
11a Flat plate portion
11b, 11c Peripheral wall
11d, 11f Tab-like portion
11e, 11g Engaging piece
12 LED assembly unit
13 LED
14 Lens
15, 16 Clip
17 Circuit substrate
18 Cover
18a Slit
19, 21 Stud
20 Bracket
31, 32 Frame member
41 Main body
41a Inner surface
41b Outer surface
411 Fin
412 Groove
41e Long hole (second long hole)
41f, 41g, 41h, 41j Recessed portion
41i Screw hole (third screw hole)
42, 43 Frame member
421, 431 Fin
422, 432 Groove
42c, 43c Long hole (first long hole)
42d, 43d Cylindrical portion
42e, 43e Screw hole (second screw hole)
42f, 43f Engaging hole
42g, 43g Hole wall
42h, 43h Stepped portion
44 Frame body
51 Screw (first screw)
52 Screw (second screw)
53 Screw (third screw)
54 Screw

1. A display apparatus, comprising:
a housing;
a display panel;
a diffusion plate arranged at a region defined by the housing and the display panel; and
a light source portion arranged at the region defined by the housing and the display panel,
wherein the diffusion plate has a first surface facing a surface opposite to a display surface of the display panel, and a second surface being a surface opposite to the first surface,
wherein the housing comprises a first part having an aperture being closed by the display panel and a second part having an inner surface facing the second surface, the second part being made of a resin, and the light source portion being arranged at the inner surface of the second portion,
wherein an outermost shell of the display apparatus is formed by the housing and the display panel,
wherein the second part comprises a main body, and a frame body surrounding the main body, the main body having a rectangular-plate shape, and
wherein the frame body comprises two first frame members and two second frame members, the two first frame members extending along a longitudinal direction of the main body and the two second frame members extending along a short direction of the main body.

2. The display apparatus according to claim 1, wherein a plurality of fins is provided in an outer surface of the main body, the plurality of fins being oriented in a vertical direction at the time of use of the display apparatus.

3. The display apparatus according to claim 1,
wherein one of the first part and the second part has a first long hole and the other of the first part and the second part has a first screw hole, and
wherein a tip of a first screw inserted into the first long hole is screwed into the first screw hole to connect the first part and the second part.

4. The display apparatus according to claim 1,
wherein the second part comprises a main body comprising the inner surface and a frame body surrounding a peripheral edge of the main body,
wherein one of the main body and the frame body has a second long hole and the other of the main body and the frame body has a second screw hole, and
wherein a tip of a second screw inserted into the second long hole is screwed into the second screw hole to connect the main body and the frame body.

5. The display apparatus according to claim 1, further comprising a reinforcing member attached to the inner surface of the second part.

6. The display apparatus according to claim 5,
wherein the reinforcing member has a third long hole and the second part has a third screw hole, and
wherein a tip of a third screw inserted into the third long hole is screwed into the third screw hole to attach the reinforcing member to the inner surface of the second part.

7. The display apparatus according to claim 1, further comprising an attaching member arranged at the inner surface of the second part, wherein the light source portion is fixed to the attaching member.

8. The display apparatus according to claim 7,
wherein the attaching member comprises an engaging piece, the engaging piece engaging a hole wall of an engaging hole provided in the second part to fix the attaching member to the second part.

9. display apparatus according to claim 1, wherein the light source portion is fixed to the inner surface of the second part.

10. The display apparatus according to claim 1, wherein the two first frame members each have a plurality of fins on an outer surface of the two first frame members, the plurality of fins extending along a short direction of the two first frame members over a longitudinal direction of the two first frame members.

11. The display apparatus according to claim 1, wherein the two second frame members each have a plurality of fins on an outer surface of the two second frame members, the plurality of fins extending along a short direction of the two second frame members over a longitudinal direction of the second frame members.

12. The display apparatus according to claim 1, wherein a gap is provided between the main body and the frame body.

13. The display apparatus according to claim 1, wherein the main body does not have hollow ribs between an inner surface, which faces the diffusion plate, of the main body facing an outer surface, which is a surface opposite to the inner surface of the main body, of the main body.

14. The display apparatus according to claim 5, wherein the reinforcing member comprises a rectangular-shaped flat plate portion and folded portions provided along a pair of long sides of the flat plate portion, a first recessed portion for accommodating the reinforcing member is formed at the inner surface of the second part, and the inner surface of the second part is flash with an inner surface of the flat plate portion.

15. The display apparatus according to claim 14, further comprising an attaching member arranged at the inner surface of the second part, and a clip for fixing the light source portion to the attaching member,
wherein the light source portion comprises a light source substrate, the clip penetrates the light source substrate, the attaching member and the flat plate portion of the reinforcing member, and an end portion of the clip protrudes toward the inner surface of the second part from a rear surface, which faces the inner surface of the second part, of the flat plate portion of the reinforcing member,
wherein the inner surface of the second part has a second recessed portion for accommodating the end portion of the clip, and
wherein the second recessed portion is provided in an area, in which the flat plate portion is accommodated, of the first recessed portion.

16. The display apparatus according to claim 14, further comprising a clip for fixing the light source portion to the attaching member,
wherein the light source portion comprises a light source substrate, the clip penetrates the light source substrate and the flat plate portion of the reinforcing member, and an end portion of the clip protrudes toward the inner surface of the second part from a rear surface, which faces the inner surface of the second part, of the flat plate portion of the reinforcing member,
wherein the inner surface of the second part has a second recessed portion for accommodating the end portion of the clip, and
wherein the second recessed portion is provided in an area, in which the flat plate portion is accommodated, of the first recessed portion.

17. The display apparatus according to claim 14, further comprising an attaching member arranged at the inner surface of the second part,
wherein the flat plate portion of the reinforcing member has a screw hole, and the attaching member is fixed to the reinforcing member by screwing a screw into the screw hole of the flat plate portion,
wherein the screw penetrates the attaching member and the flat plate portion of the reinforcing member, and a tip of the screw protrudes toward the inner surface of the second part from a rear surface, which faces the inner surface of the second part, of the flat plate portion of the reinforcing member,
wherein the inner surface of the second part has a third recessed portion for accommodating the tip of the screw, and
wherein the third recessed portion is provided in an area, in which the flat plate portion is accommodated, of the first recessed portion.
